(19) United States
(12) Patent Application Publication
(10) Pub. No.: US 2025/0387882 A1
(43) Pub. Date: Dec. 25, 2025

(54) OPEN-END WRENCH

(71) Applicants: Yi-Fu Chen, TAICHUNG CITY (TW); He-Qian Chen, Taichung City (TW)

(72) Inventors: Yi-Fu Chen, TAICHUNG CITY (TW); He-Qian Chen, Taichung City (TW)

(21) Appl. No.: 18/747,452

(22) Filed: Jun. 19, 2024

(51) Int. Cl. B25B 13/08

(52) U.S. Cl. CPC B25B 13/08

(57) ABSTRACT

An open-end wrench includes a working head and a handle which is formed with the working head. The working head includes an open slot which is formed by multiple driving surfaces, and has an access opening. An arcuate groove is formed between adjacent driving surfaces. Each driving surface has a concave sharp recess that forms an angle less than 90 degrees. The sharp recess is located in the middle of the driving surface corresponding thereto for gripping corners of screws. When in use, even if the screw corners are extensively damaged, the angled sharp recesses can find a gripping point to assist in turning the screw.

### FIELD OF THE INVENTION

The present invention relates to a hand tool, and more particularly, to an open-end wrench used for tightening and loosening target objects.

### BACKGROUND OF THE INVENTION

A wrench is a common hand tool generally used for loosening and tightening screws, nuts, and bolts. Despite the rapid advancement of technology today, the wrench remains an irreplaceable hand tool, and its demand continues to grow. Consequently, many new comers have entered the wrench manufacturing industry, resulting in fierce competition. It is quite challenging for industry participants to maintain product quality while also keeping prices competitive.

Machinery and equipment that require maintenance with a wrench generally need to be disassembled, repaired, or have parts replaced after years of regular use. Screws on such equipment, which haven't been removed for long periods, often become difficult to unscrew due to external factors like rust. Therefore, when workers attempt to remove these screws, they need to apply considerable force. This increased force makes the wrench prone to slipping, which can deform or damage the edges of the screws.

When traditional wrenches are used on screws with damaged edges, they tend to slip even more, exacerbating the damage to the screw edges. Once the edges of a screw are damaged beyond a certain point, the screw becomes unusable and must be discarded. Thus, there is a significant need to address the problem of traditional wrenches slipping on screws with damaged edges.

The present invention intends to provide an open-end wrench to eliminate the shortcomings mentioned above.

### SUMMARY OF THE INVENTION

The present invention relates to an open-end wrench and comprises a working head and a handle which is formed with the working head. The working head has an open slot which is formed by multiple driving surfaces and has an access opening. An arcuate groove is formed between adjacent driving surfaces. Each driving surface has a concave sharp recess that forms an angle less than 90 degrees. The sharp recess is located in the middle of the driving surface corresponding thereto for gripping corners of screws.

Preferably, each driving surface includes a first surface section and a second surface section, with the sharp recess located between the first surface section and the second surface section.

Preferably, there are four driving surfaces, and an angle between adjacent driving surfaces is 60 degrees.

Preferably, a curvature of the arcuate groove is greater than π/2 radians.

Preferably, a linear distance between two adjacent arcuate grooves is greater than a linear distance between two adjacent sharp recesses.

The primary object of the present invention is to provide an open-end wrench wherein each driving surface includes a sharp recess, designed in an angled shape. This structure allows screws with minor edge damage to find a gripping point in the arcuate groove to assist in turning the screw. For screws with extensive edge damage, the angled sharp recesses provide a gripping point to assist in turning. The present invention addresses the problem of traditional wrenches slipping more easily when applied to screws with damaged edges, significantly improving the efficiency of maintenance personnel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the open-end wrench of the present invention;

FIG. 2 is a planar view of the working head of the present invention;

FIG. 3 is an actual usage view of the present invention applied to a screw with undamaged edges;

FIG. 4 is a first reference view of the present invention in actual use on a screw with damaged edges;

FIG. 5 is a second reference view of the present invention in actual use on a screw with damaged edges, and

FIG. 6 is a third reference view of the present invention in actual use on a screw with damaged edges.

### DETAILED DESCRIPTION OF THE PREFERRED EMBODIMENT

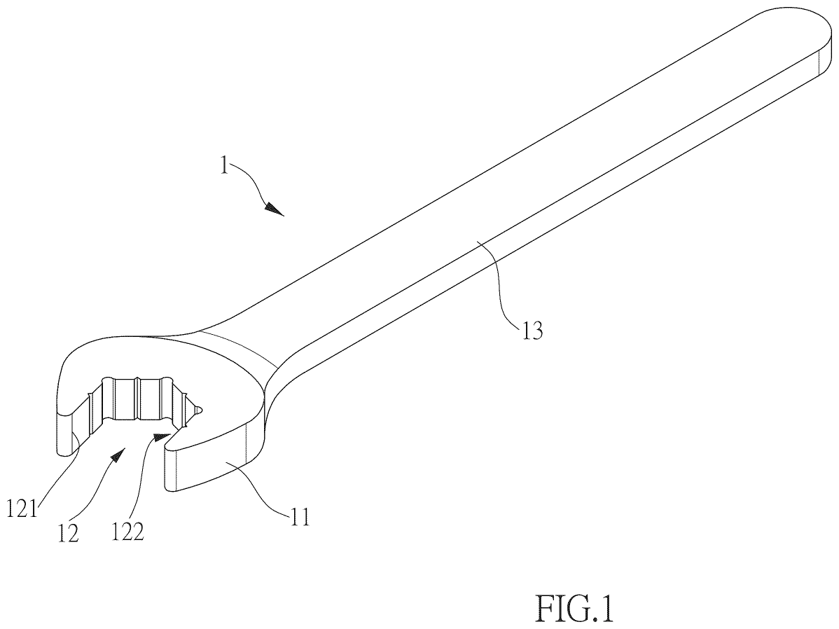

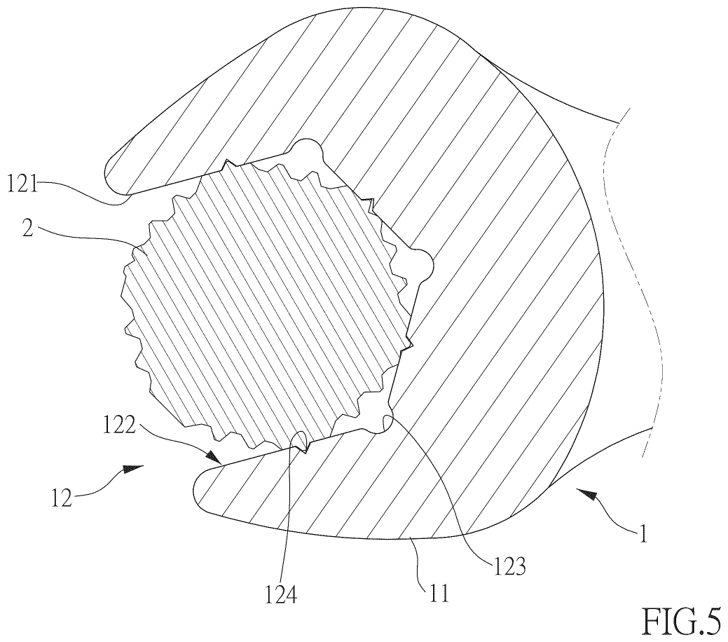

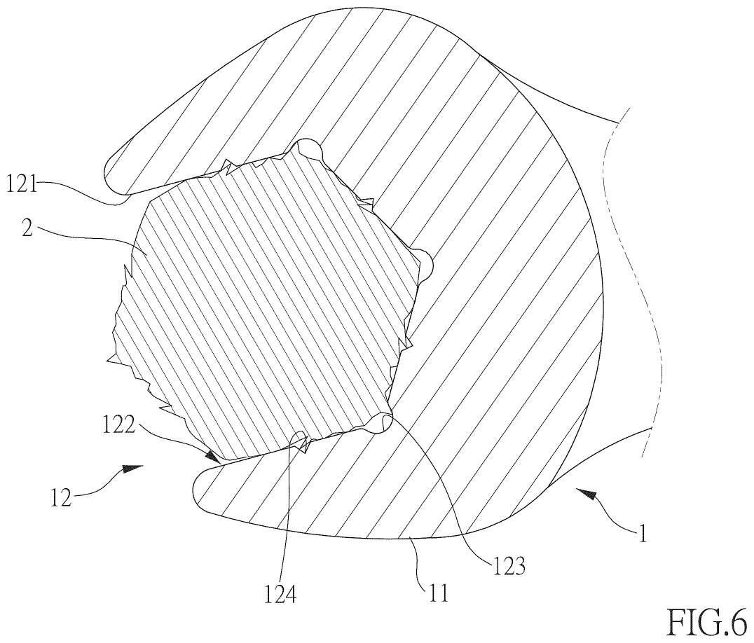

Referring to FIGS. 1 to 6, the open-end wrench (1) of the present invention comprises a working head (11) and a handle (13) which is formed with the working head (11). The working head (11) includes an open slot (12) which is formed by multiple driving surfaces (122) and has an access opening (121). An arcuate groove (123) is formed between adjacent driving surfaces (122). Each driving surface (122) has a concave sharp recess (124) that forms an angle less than 90 degrees. The sharp recess (124) is located in the middle of the driving surface (122) corresponding thereto for gripping corners of screws (2).

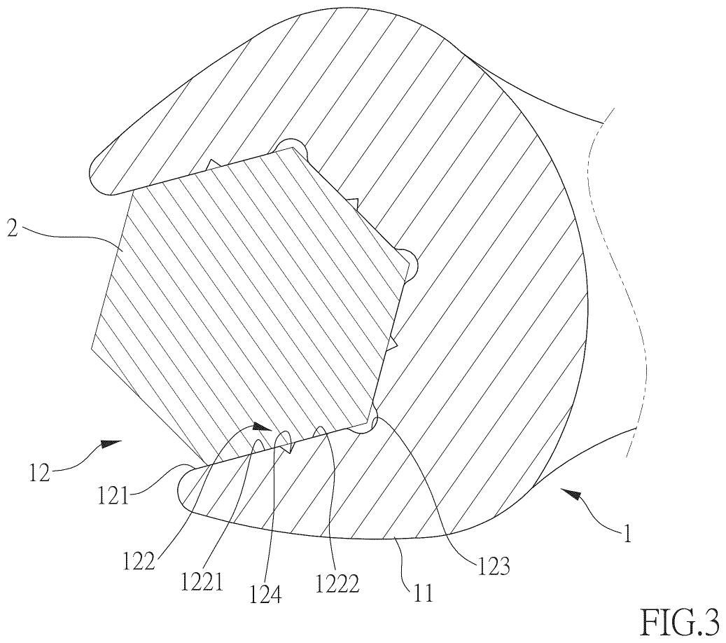

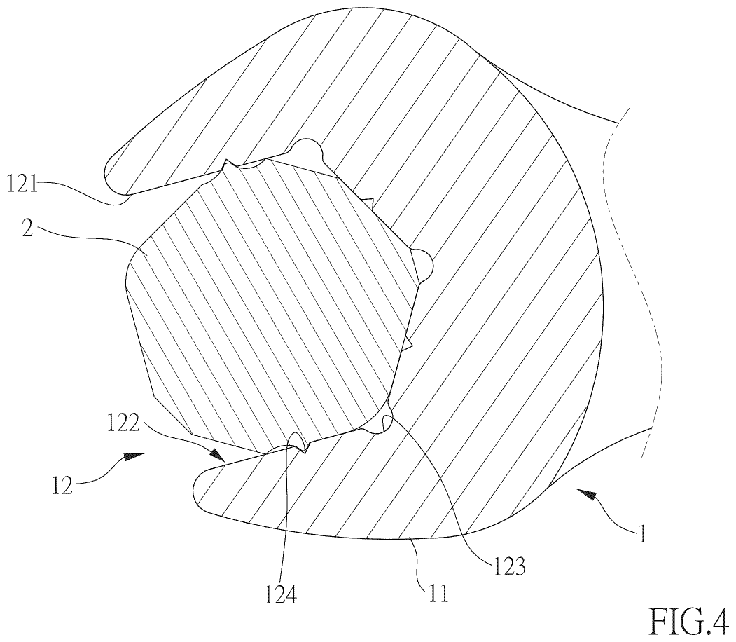

In order to address the issues found in conventional products, the open-end wrench (1) of the present invention features each driving surface (122) equipped with a sharp recess (124) which is angled. The sharp recesses (124) allow screws (2) with undamaged edges (as shown in FIG. 3) or minor edge damage to find a gripping point in the arcuate groove (123) to assist in turning the screw (2). As shown in FIGS. 4 to 6, the preset invention also enables screws (2) with extensive edge damage to find a gripping point in the sharp recesses (124) to assist in turning.

From the comprehensive overview above, it is clear that maintenance personnel can use the arcuate grooves (123) to grip standard screws (2) or those with minor edge damage. The arcuate grooves (123) allow the edges of screws (2) in various conditions to be gripped, enabling the invention to turn the screw (2). If the screw (2) has extensive edge damage, the sharp recesses (124) on the driving surface (122) can grip the damaged edges, allowing the present invention to turn the screw (2) for tightening or loosening. This significantly improves the issue of traditional wrenches slipping on screws (2) with damaged edges, greatly enhancing the efficiency of maintenance personnel. This invention is both novel and progressive.

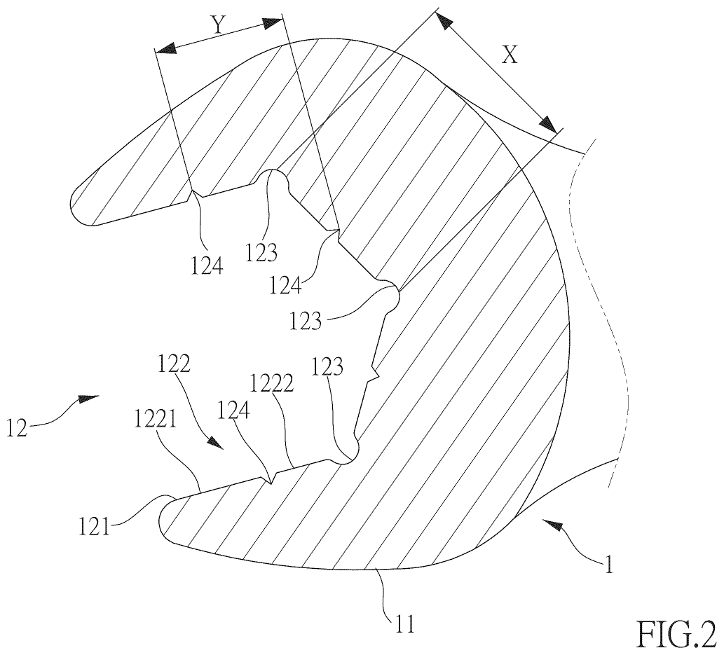

As shown in FIG. 2, each driving surface (122) includes a first surface section (1221) and a second surface section (1222), with the sharp recess (124) located between the first surface section (1221) and the second surface section (1222).

As shown in FIGS. 1 to 6, in one embodiment that the present invention is applied to a hexagonal screw (2), there are four driving surfaces (122), and an angle between adjacent driving surfaces (122) is 60 degrees. The detailed description of the aforementioned structure is provided solely for the convenience of those skilled in the art to understand the implementation of the invention and is not the only specification. The number of driving surfaces (122) can be designed with different numbers of surfaces according to actual needs to match the common types of screws available on the market.

Furthermore, the curvature of the arcuate groove (123) is greater than π/2 radians. The arcuate grooves (123) are primarily used to grip screws (2) that are undamaged or have minor edge damage.

Furthermore, as shown in FIG. 2, a linear distance “X” between two adjacent arcuate grooves (123) is greater than a linear distance “Y” between two adjacent sharp recesses (124).

This structure ensures that even if the edges of the screw (2) are extensively damaged and cannot be gripped by the arcuate grooves (123), the sharp recesses (124) can still grip screws with more severe edge damage.

While we have shown and described the embodiment in accordance with the present invention, it should be clear to those skilled in the art that further embodiments may be made without departing from the scope of the present invention.

What is claimed is:

1. An open-end wrench (1) comprising:
a working head (11) and a handle (13) which is formed with the working head (11), the working head (11) having an open slot (12) which is formed by multiple driving surfaces (122) and has an access opening (121), an arcuate groove (123) formed between adjacent driving surfaces (122), each driving surface (122) having a concave sharp recess (124) that forms an angle less than 90 degrees, the sharp recess (124) located in the middle of the driving surface (122) corresponding thereto for gripping corners of screws (2).

2. The open-end wrench as claimed in claim 1, wherein each driving surface (122) includes a first surface section (1221) and a second surface section (1222), with the sharp recess (124) located between the first surface section (1221) and the second surface section (1222).

3. The open-end wrench as claimed in claim 1, wherein there are four driving surfaces (122), and an angle between adjacent driving surfaces (122) is 60 degrees.

4. The open-end wrench as claimed in claim 1, wherein a curvature of the arcuate groove (123) is greater than π/2 radians.

5. The open-end wrench as claimed in claim 1, wherein a linear distance between two adjacent arcuate grooves (123) is greater than a linear distance between two adjacent sharp recesses (124).
